(19) United States
(12) Patent Application Publication
(10) Pub. No.: US 2017/0187601 A1
(43) Pub. Date: Jun. 29, 2017

(54) PARALLEL INFORMATION PROCESSING DEVICE, DATA TRANSFER METHOD, AND COMPUTER-READABLE RECORDING MEDIUM

(71) Applicant: FUJITSU LIMITED, Kawasaki-shi (JP)

(72) Inventors: Yasumasa Nakano, Fuji (JP); Tsuyoshi HASHIMOTO, Kawasaki (JP)

(73) Assignee: FUJITSU LIMITED, Kawasaki-shi, Kanagawa (JP)

(21) Appl. No.: 15/292,706

(22) Filed: Oct. 13, 2016

(30) Foreign Application Priority Data
Dec. 28, 2015 (JP) 2015-257016

(51) Int. Cl. H04L 12/26; H04L 29/06

(52) U.S. Cl. CPC H04L 43/0888; H04L 69/22

(57) ABSTRACT

A data division unit divides transfer data into pieces of partial data to be transferred for each route. A first transfer unit transmits a first partial data via a dimension-order routing route, among pieces of partial data acquired by division, and a second transfer unit transmits a second partial data different from the first partial data via a relay node route to a relay node.

### CROSS-REFERENCE TO RELATED APPLICATION

This application is based upon and claims the benefit of priority of the prior Japanese Patent Application No. 2015-257016, filed on Dec. 28, 2015, the entire contents of which are incorporated herein by reference.

### FIELD

The embodiment discussed herein is related to a parallel information processing device, a data transfer method, and a computer-readable recording medium.

### BACKGROUND

A cluster system in which a plurality of calculation nodes are connected by interconnection in a mesh shape or a torus shape in an arbitrary dimension has a log management function for collecting pieces of log data acquired by respective calculation nodes in a certain node, which is referred to as “IO node”. The calculation node here means an information processing device that performs parallel processing with other calculation nodes. The IO node can also function as the calculation node.

Each of the calculation nodes transmits acquired log data to the IO node according to a dimension-order routing. The dimension-order routing here means a routing method of transferring data in a predetermined dimension order. FIG. 14 is an explanatory diagram of dimension-order routing. FIG. 14 illustrates a case where a plurality of calculation nodes are connected in a two-dimensional mesh shape.

In FIG. 14, respective calculation nodes 2 are identified by a coordinate on an x-axis and a y-axis. For example, by designating a lower left corner as an origin, a calculation node 2 at the lower left corner is identified by (0, 0), a calculation node at a lower right corner is identified by (5, 0), and a calculation node at an upper left corner is identified by (0, 5). As illustrated in FIG. 14, when the calculation node 2 identified by (0, 0) transfers the log data to an IO node 3 at an upper right corner, the calculation node 2 identified by (0, 0) first transmits the log data to a calculation node 2 identified by (5, 0) in an x-axis direction. The calculation node 2 identified by (5, 0) then transmits the received log data to the IO node 3 identified by (5, 5) in a y-axis direction.

In this manner, in the dimension-order routing, an order of a coordinate axis indicating a transfer direction of data is defined. In the example illustrated in FIG. 14, the log data is first transferred in the x-axis direction, and when the log data is transferred to the calculation node 2 in which the x coordinate is the same as the IO node 3, the log data is then transferred to the IO node 3 in the y-axis direction. That is, in the example illustrated in FIG. 14, data is transferred in the order of x→y regarding the coordinate axis. Because the dimension-order routing can be realized by a simple logic circuit, the need of a routing table for holding route information is eliminated, and a small hardware amount will do.

In a computer system that decides a hop destination of data among a plurality of routers by the dimension-order routing, there is a technique of improving a throughput by deciding a hop destination of control data from a transmission source of data to a transmission destination thereof as an adjacent router in a different route from a data transfer route. Further, there is a technique of decreasing a latency in route selection by rewriting route information held in a route-information holding unit based on collected pieces of congestion information and causing a transmission unit to perform communication instructed by an arithmetic processing unit based on rewritten route information.

In a large-scale parallel processing system, there is a technique in which a special physical communication link used only for a maintenance function is removed by including a non-block type virtual maintenance network that is not flow-controlled, in order to realize the maintenance function. Further, there is a technique in which a plurality of level adjustment processes of retaining link status information and downstream information such as a filled state of a downstream buffer in a compact vector are used to determine a preferable direction and a virtual channel for packet transmission, thereby eliminating the need for a route table.

[Patent Literature 1] Japanese Laid-open Patent Publication No. 2014-241474

[Patent Literature 2] Japanese Laid-open Patent Publication No. 2012-216078

[Patent Literature 3] Japanese Laid-open Patent Publication No. 2004-118855

[Patent Literature 4] Japanese National Publication of International Patent Application No. 2004-527176

However, there is a problem in the dimension-order routing illustrated in FIG. 14 such that loads are concentrated in a certain part of the links. In FIG. 14, in a case where the calculation node 2 at a stage other than the uppermost stage is to transmit log data to the IO node 3, a link b is always used. Therefore, loads are concentrated in the link b. On the other hand, because a link a is used only for the calculation nodes 2 at the uppermost stage, a load of the link a is not large.

### SUMMARY

According to an aspect of an embodiment, a parallel information processing device in which a plurality of information processing devices that perform parallel processing are connected in a mesh shape or a torus shape, wherein each of the information processing devices includes a division unit that divides data into pieces of partial data depending based on number of dimensions of parallel processing, a first transmission unit that transmits first partial data acquired by division among the pieces of partial data divided by the division unit to a certain information processing device via a first route based on a dimension-order routing, and a second transmission unit that transmits second partial data different from the first partial data, among the pieces of partial data acquired by division divided by the division unit, to the certain information processing device via a second route with a different dimension order from that of the first route.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a cluster system according to an embodiment;

FIG. 2 is an explanatory diagram of routing according to the embodiment;

FIG. 3 is a diagram illustrating a functional configuration of a node according to the embodiment;

FIG. 4 is a diagram illustrating an example of a route-information storage unit;

FIG. 5 is a diagram illustrating an example of a performance-information storage unit;

FIG. 6 is a diagram illustrating a format example of partial data acquired by dividing data;

FIG. 7 is a flowchart illustrating a flow of a data transfer process;

FIG. 8 is a flowchart illustrating a flow of a performance measuring process;

FIG. 9 is a flowchart illustrating a flow of a data dividing process;

FIG. 10 is a flowchart illustrating a flow of a partial-data receiving process performed by a relay node;

FIG. 11 is a flowchart illustrating a flow of a data synthesizing process;

FIG. 12 is an explanatory diagram of routing in a two-dimensional torus;

FIG. 13 is a diagram illustrating a hardware configuration of a calculation node; and

FIG. 14 is an explanatory diagram of dimension-order routing.

### DESCRIPTION OF EMBODIMENT

Preferred embodiments of the present invention will be explained with reference to accompanying drawings. The embodiment does not limit the technique disclosed in the present application.

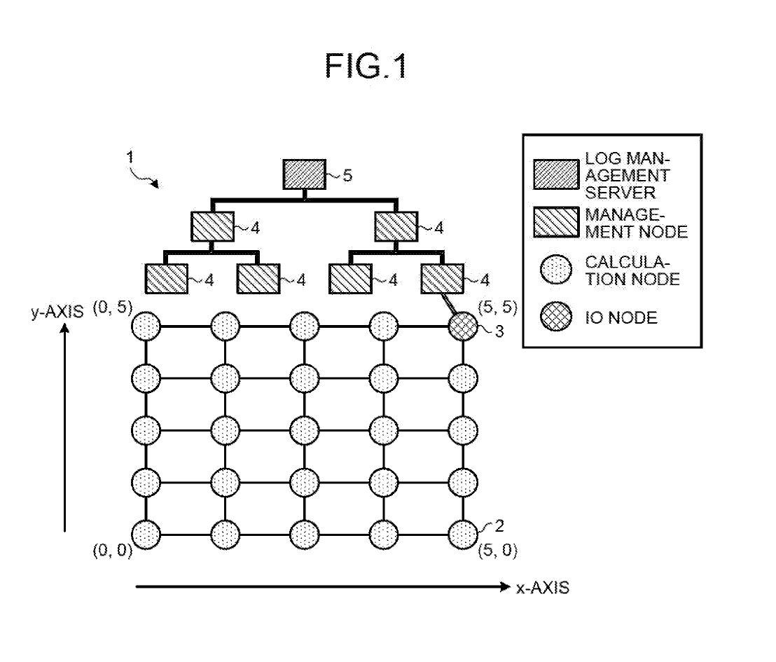

A configuration of a cluster system according to an embodiment is described first. FIG. 1 is a diagram illustrating a configuration of the cluster system according to the present embodiment. As illustrated in FIG. 1, a cluster system 1 includes a plurality of calculation nodes 2 connected to each other by interconnection in a mesh shape, an IO node 3 arranged at an upper right corner of a mesh, a plurality of management nodes 4, and a log management server 5.

The calculation node 2 is an information processing device that performs parallel processing while communicating with other calculation nodes 2. The IO node 3 is an information processing device that performs input/output processing with the management node 4 including output processing of log data acquired by the respective calculation nodes 2. The log data includes a log of power consumption. The IO node 3 can function also as the calculation node 2.

The respective calculation nodes 2 are identified by a coordinate on an x-axis and a y-axis. In FIG. 1, by designating a lower left corner as an origin, the calculation node 2 at a lower left corner is identified by (0, 0), the calculation node 2 at a lower right corner is identified by (5, 0), and the calculation node 2 at an upper left corner is identified by (0, 5). The coordinate of the IO node 3 is (5, 5).

The management node 4 is a management device that manages the calculation node 2. The log data output by the IO node 3 is relayed by the plurality of management nodes 4, and is transmitted to the log management server 5. In FIG. 1, six management nodes 4 are arranged in a two-level hierarchy. However, more management nodes 4 can be arranged in a multi-level hierarchy. In FIG. 1, the two calculation nodes 2 in a higher layer are respectively connected to two management nodes 4 in a lower layer. However, more management nodes 4 in the higher layer can be connected to more management nodes 4 in the lower layer. The management nodes are connected to each other by a GB (gigabit) Ethernet®.

The IO node 3 is connected to one of the management nodes 4 in the lower layer by the GB Ethernet®. In FIG. 1, only one management node 4 is connected to the IO node 3. However, the other management nodes 4 in the lower layer are respectively connected to other IO nodes 3 respectively. That is, the cluster system 1 includes four IO nodes 3, and 96 (=24×4) calculation nodes 2. The cluster system 1 can include more than four IO nodes 3 and more than 96 calculation nodes 2, or less than four IO nodes 3 and less than 96 calculation nodes 2.

While the calculation nodes 2 are arranged two-dimensionally in FIG. 1, they can be arranged in an arbitrary dimension. Also, while the calculation nodes 2 are arranged in a mesh shape in FIG. 1, they can be arranged in a torus shape.

The log management server 5 manages the log data acquired by the respective calculation nodes 2. The log management server 5 and the respective management nodes 4 in the higher layer are connected to each other by the GB Ethernet®.

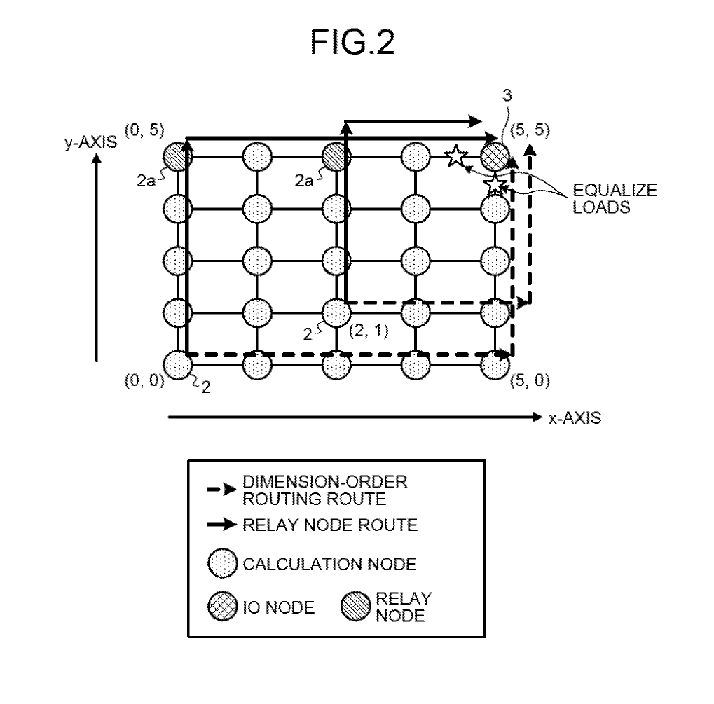

Routing according to the present embodiment is described next. FIG. 2 is an explanatory diagram of the routing according to the present embodiment. FIG. 2 illustrates a case where a calculation node 2 identified by (0, 0) and a calculation node 2 identified by (2, 1) transmit log data to the IO node 3. As illustrated in FIG. 2, the calculation node 2 identified by (0, 0) and the calculation node 2 identified by (2, 1) transfer the log data via two routes by dividing the log data. One route is based on dimension-order routing, and the other route is based on a dimension order different from the dimension-order routing.

In the route based on the dimension-order routing, data is transferred in the order of x→y regarding the direction of the coordinate axis. On the other hand, in the route based on the dimension order different from the dimension-order routing, the data is transferred in the order of y→x regarding the direction of the coordinate axis. The log data is divided into two based on the performance of the respective routes.

However, if one coordinate is equal to the IO node 3 as a destination, like the calculation node 2 identified by (5, 0) and the calculation node 2 identified by (0, 5), the calculation node 2 transmits the log data by using one route. That is, if there are a route based on the dimension-order routing and a route based on the dimension order different from the dimension-order routing, the respective calculation nodes 2 transmit the log data via the two routes by dividing the log data.

The respective calculation nodes 2 can prevent concentration of loads in the link b by transmitting the log data via the two routes. In the following descriptions, for convenience of explanation, the route based on the dimension-order routing is referred to as “dimension-order routing route”, and the route based on the dimension order different from the dimension-order routing is referred to as “relay node route”. The “relay node” is the calculation node 2 that transmits data in a direction of a coordinate axis different from the direction of a received coordinate axis.

For example, in FIG. 2, the relay node with regard to the calculation node 2 identified by (0, 0) is the calculation node 2 identified by (0, 5). The calculation node 2 identified by (0, 5) transmits data received in a y-axis direction in an x-axis direction. The relay node with regard to the calculation node 2 identified by (2, 1) is the calculation node 2 identified by (2, 5).

When the calculation nodes 2 are connected in a three-dimensional mesh shape, the calculation node 2 has 6 (=3×2) routes. Specifically, the calculation node 2 has six routes to transfer data in the order of x→y→z, x→z→y, z→x→y, and z→y→x. Two relay nodes are included in the respective relay node routes.

Generally, in a case where n is a positive integer and the calculation nodes 2 are connected in an n-dimensional mesh shape, the calculation node 2 includes n×(n−1)×(n−2)× . . . ×2=n! routes, if the IO nodes 3 and n coordinates are all different. The respective relay node routes include (n−1) relay nodes. When the calculation nodes 2 are connected in an n-dimensional torus shape, the calculation node 2 has 2n! routes if the IO nodes 3 and n coordinates are all different. The respective relay node routes include (n−1) relay nodes.

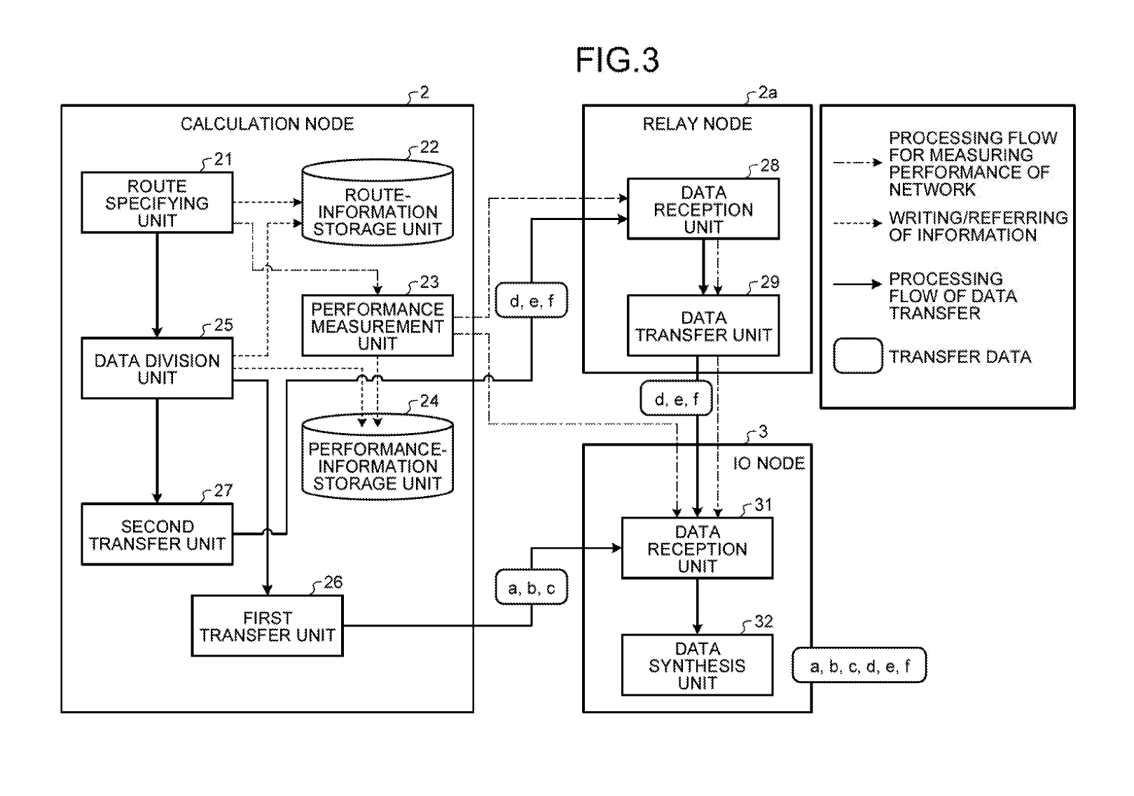

A functional configuration of the node according to the present embodiment is described next. FIG. 3 is a diagram illustrating a functional configuration of the node according to the present embodiment. As illustrated in FIG. 3, the calculation node 2 includes a route specifying unit 21, a route-information storage unit 22, a performance measurement unit 23, a performance-information storage unit 24, a data division unit 25, a first transfer unit 26, and a second transfer unit 27. A relay node 2a includes a data reception unit 28 and a data transfer unit 29. The IO node 3 includes a data reception unit 31 and a data synthesis unit 32.

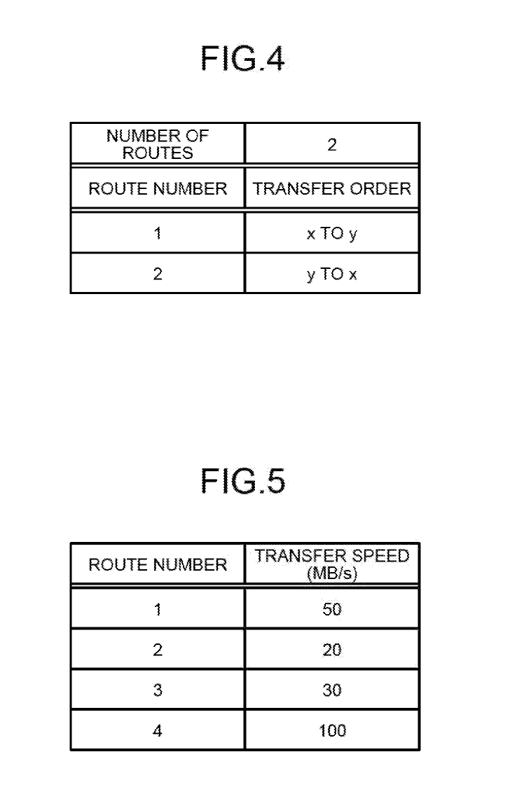

The route specifying unit 21 specifies the dimension-order routing route and all relay node routes from its own node to the IO node 3. The route specifying unit 21 stores information related to the specified route in the route-information storage unit 22 as route information. The route-information storage unit 22 stores therein the information of the route specified by the route specifying unit 21. FIG. 4 is a diagram illustrating an example of the route-information storage unit 22. As illustrated in FIG. 4, the route-information storage unit 22 stores therein the number of routes and information of each route. The information of each route includes the number of routes and a transfer order.

The number of routes is a number obtained by adding 1 to the number of relay node routes as the number of dimension-order routing routes. FIG. 4 illustrates a case where the calculation nodes 2 are connected in a two-dimensional mesh shape, and the number of routes is two. The route number identifies the route. The transfer order indicates an order of the direction of the coordinate axis to transfer the data. In FIG. 4, data is transferred in the order of x→y in a route having the number of “1”, and data is transferred in the order of y→x in a route having the number of “2”.

The performance measurement unit 23 transfers data to the respective routes and measures a transfer data amount per unit time to measure the performance of the network. The performance measurement unit 23 writes a measured value in the performance-information storage unit 24. The performance-information storage unit 24 stores therein the transfer data amount per unit time as performance information, with regard to the respective routes.

FIG. 5 is a diagram illustrating an example of the performance-information storage unit 24. FIG. 5 illustrates a case where the calculation nodes 2 are connected in a two-dimensional torus shape. As illustrated in FIG. 5, the performance-information storage unit 24 stores therein the route number and the transfer speed for each route. The route number identifies the route. The transfer speed is a data transfer amount per one s (second). The unit of the data transfer amount is MB (megabyte). For example, in the route having the number of “1”, data having 50 MB/s is transferred.

The data division unit 25 divides the transfer data based on the transfer speed of respective routes. Specifically, the data division unit 25 divides the transfer data, and sets a ratio of partial data to be transferred in each route as “(transfer speed of route)/(total of transfer speed of all routes)”. For example, in FIG. 5, in the route having the number of “1”, partial data of 50/(50+20+30+100)=50/200=0.25=25% is transferred.

The first transfer unit 26 transfers partial data for the dimension-order routing route via the dimension-order routing route. In FIG. 3, pieces of partial data “a, b, c” are transferred to the IO node 3 via the dimension-order routing route as an example of a case where the calculation nodes 2 are connected in a two-dimensional mesh shape.

The second transfer unit 27 transfers the partial data for each relay node route via the corresponding relay node route. When the calculation nodes 2 are connected in an n-dimensional mesh shape, the second transfer unit 27 transfers the data via (n!−1) relay node routes. When the calculation nodes 2 are connected in the n-dimensional torus shape, the second transfer unit 27 transfers the data via (2n!−1) relay node routes. In FIG. 3, pieces of partial data “d, e, f” is transferred via the relay node route as an example when the calculation nodes 2 are connected in a two-dimensional mesh shape.

The data reception unit 28 receives the partial data transmitted from the source calculation node 2, and transmits the received partial data to the data transfer unit 29. The data transfer unit 29 refers to the route information included in a header of the partial data, and transfers the partial data to the IO node 3 or the relay node 2a.

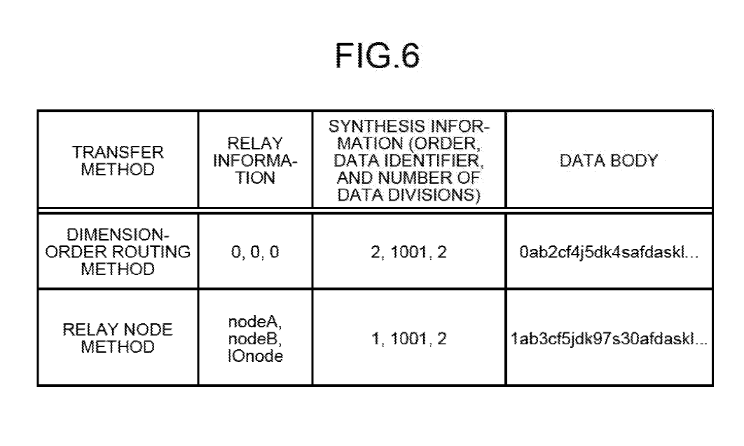

FIG. 6 is a diagram illustrating a format example of partial data acquired by dividing data. As illustrated in FIG. 6, the partial data acquired by dividing the data includes a transfer method, relay information, synthesis information, and a data body. The transfer method indicates whether the method is a “dimension-order routing method” or a “relay node method”.

The relay information indicates an identifier of a relay node and an identifier of the IO node 3. The “dimension-order routing method” eliminates the need of the relay information. For example, according to the “relay node method”, the relay information indicates “nodeA” and “nodeB” as the identifiers of the relay nodes, and indicates “IOnode” as the identifier of the IO node 3. According to the “dimension-order routing method”, the relay information is “0, 0, 0”, indicating that there is no relay node.

The synthesis information indicates the order of synthesis of partial data, a data identifier, and the number of data divisions. For example, the second partial data of the data identified by “1001” and divided into two is transferred by the “dimension-order routing method”, and the first partial data identified by “1001” and divided into two is transferred by the “relay node method”.

The transfer method, the relay information, and the synthesis information are included in a header of the divided data. The data body is data to be divided and transferred. For example, “0ab2cf4j5dk4safdaskl . . . ” is transferred as the data body by the “dimension-order routing method”, and “1ab3cf5jdk97s30afdaskl . . . ” is transferred as the data body by the “relay node method”.

The data reception unit 31 receives the partial data transmitted from the calculation node 2 or the relay node 2a and transmits the partial data to the data synthesis unit 32. The data synthesis unit 32 refers to the header of the transmitted partial data to synthesize the divided and transmitted pieces of partial data based on the order, the data identifier, and the number of data divisions included in the header to restore the data before the division. In FIG. 3, the pieces of partial data “a, b, c” transmitted via the dimension-order routing route and the pieces of partial data “d, e, f” transmitted via the relay node route are synthesized and the data before the division “a, b, c, d, e, f” is restored.

In FIG. 3, dot-and-dash lines indicate a flow of a process of measuring the performance of a network, broken lines indicate writing or referring to of information, and solid lines indicate a flow of a data transfer process.

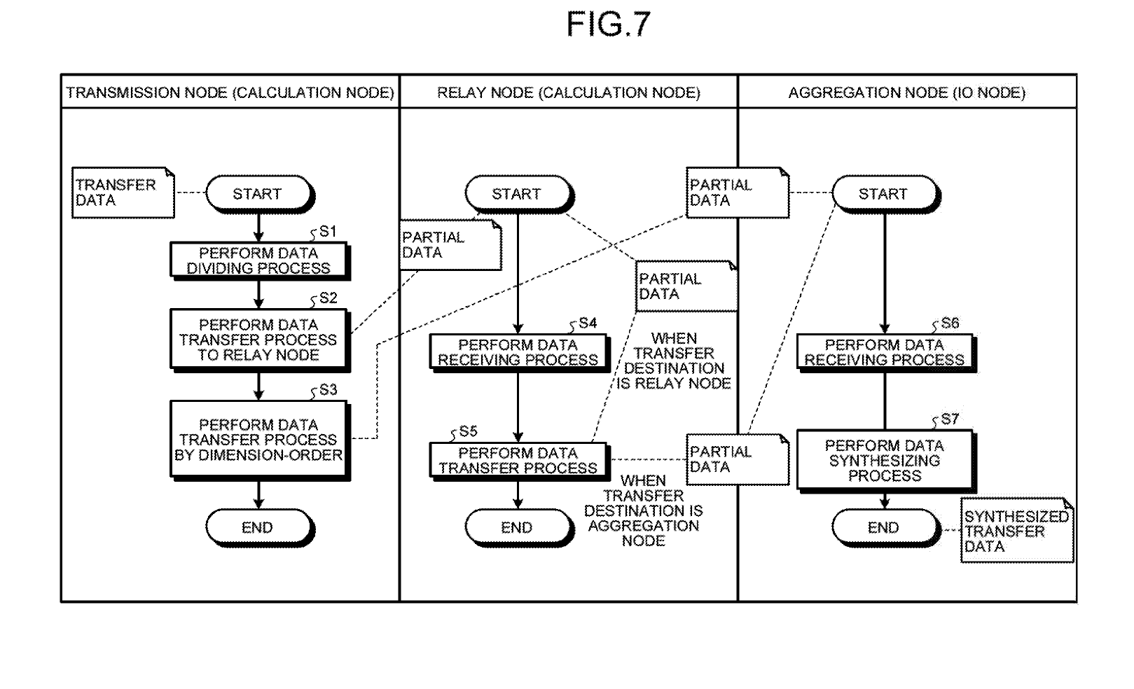

A flow of the data transfer process is described next. FIG. 7 is a flowchart illustrating a flow of the data transfer process. In FIG. 7, a transmission node is the calculation node 2 that transmits data to the IO node 3, and an aggregation node is the IO node 3 that aggregates the divided data. Solid lines indicate a flow of the process, and broken lines indicate a flow of data.

As illustrated in FIG. 7, the transmission node performs a data dividing process to divide data (Step S1), and performs a data transfer process to the relay node 2a and a data transfer process by the dimension-order routing (Steps S2 to S3). Any of the processes at Steps S2 and S3 can be performed first.

The relay node 2a performs a data receiving process for receiving the partial data (Step S4), and performs the data transfer process of transferring the received partial data to the relay node 2a or the aggregation node based on the relay information included in the header of the received partial data (Step S5).

The aggregation node performs the data receiving process for receiving the partial data transmitted via the relay node route or the dimension-order routing route (Step S6). The aggregation node performs a synthesis process for synthesizing the partial data based on the order, the data identifier, and the number of data divisions included in the header of the received partial data (Step S7).

In this manner, the transmission node can prevent concentration of communication loads in a certain link by transmitting the partial data to the aggregation node via the relay node route and the dimension-order routing route.

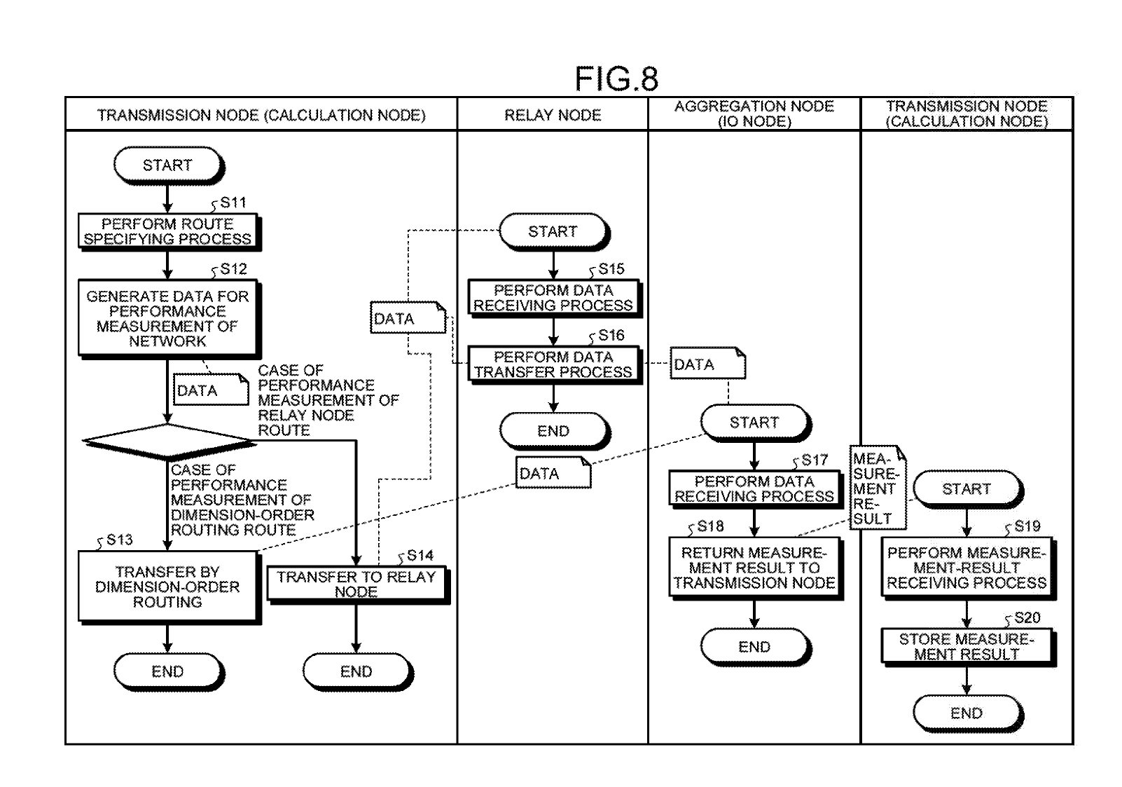

A flow of a performance measuring process for measuring performance of a network is described next. FIG. 8 is a flowchart illustrating a flow of the performance measuring process. As illustrated in FIG. 8, a transmission node performs a route specifying process for specifying a relay node route and a dimension-order routing route to the IO node 3 (Step S11). The transmission node then generates data for performance measurement of the network (Step S12).

In the case of performance measurement of the dimension-order routing, the transmission node transfers the generated data by the dimension-order routing (Step S13), or in the case of performance measurement of the relay node route, transfers the generated data to the relay node 2a (Step S14).

The relay node 2a performs the data receiving process for receiving the data (Step S15), and performs the data transfer process for transferring the received data to the relay node 2a or the aggregation node (Step S16).

The aggregation node performs the data receiving process for receiving the data (Step S17), and returns a measurement result to the transmission node (Step S18). The transmission node then performs a measurement-result receiving process for receiving the measurement result (Step S19), and stores therein the received measurement result (Step S20).

In this manner, the transmission node can divide transfer data as appropriate by performing performance measurement of the dimension-order routing route and the relay node route.

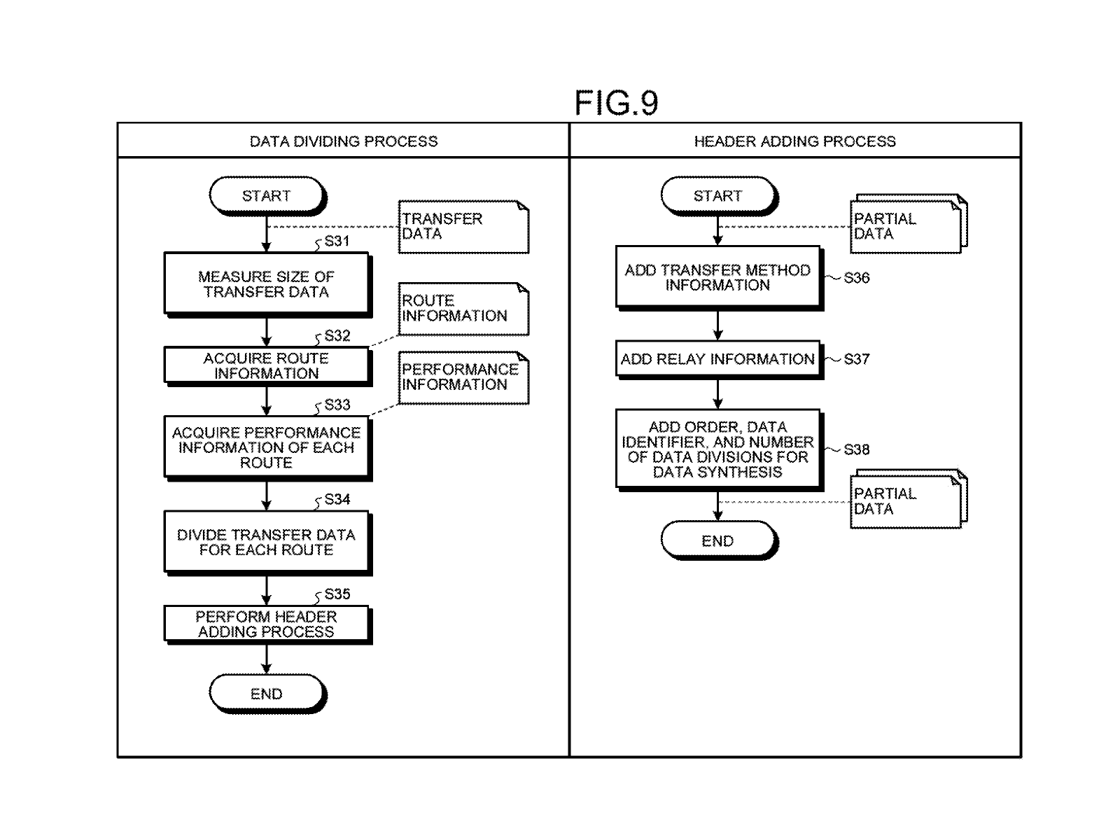

A flow of a data dividing process is described next. FIG. 9 is a flowchart illustrating a flow of the data dividing process. The data dividing process corresponds to the process at Step S1 illustrated in FIG. 7.

As illustrated in FIG. 9, the transmission node measures the size of the transfer data (Step S31). The transmission node acquires the route information from the route-information storage unit 22 (Step S32), and acquires the performance information of each route from the performance-information storage unit 24 (Step S33).

The transmission node divides the transfer data for each route based on the size of the transfer data, the route information, and the performance information (Step S34), and performs a header adding process for adding a header to the partial data acquired by dividing the data (Step S35).

Specifically, in the header adding process, the transmission node adds transfer method information (Step S36), adds the relay information (Step S37), and adds the order, the data identifier, and the number of data divisions for synthesizing the data (Step S38).

In this manner, the transmission node can decrease the difference in time at which the partial data reaches the IO node 3 by dividing the transfer data based on the performance information stored in the performance-information storage unit 24 for each of the routes.

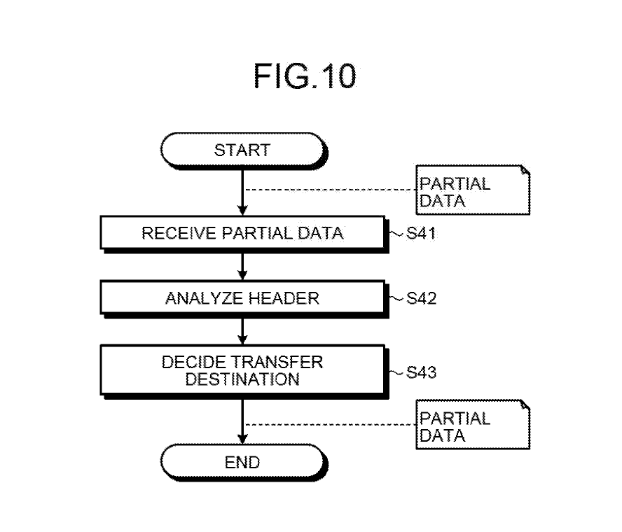

A flow of a partial-data receiving process performed by the relay node 2a is described next. FIG. 10 is a flowchart illustrating the flow of the partial-data receiving process performed by the relay node 2a. The receiving process corresponds to the process at Step S4 illustrated in FIG. 7.

As illustrated in FIG. 10, the relay node 2a receives transferred partial data (Step S41) and analyzes the header of the received partial data (Step S42). The relay node 2a then decides a transfer destination of the received partial data based on an analysis result of the header (Step S43).

In this manner, the relay node 2a can decide the transfer destination of the partial data transferred via the relay node route by analyzing the header of the received partial data.

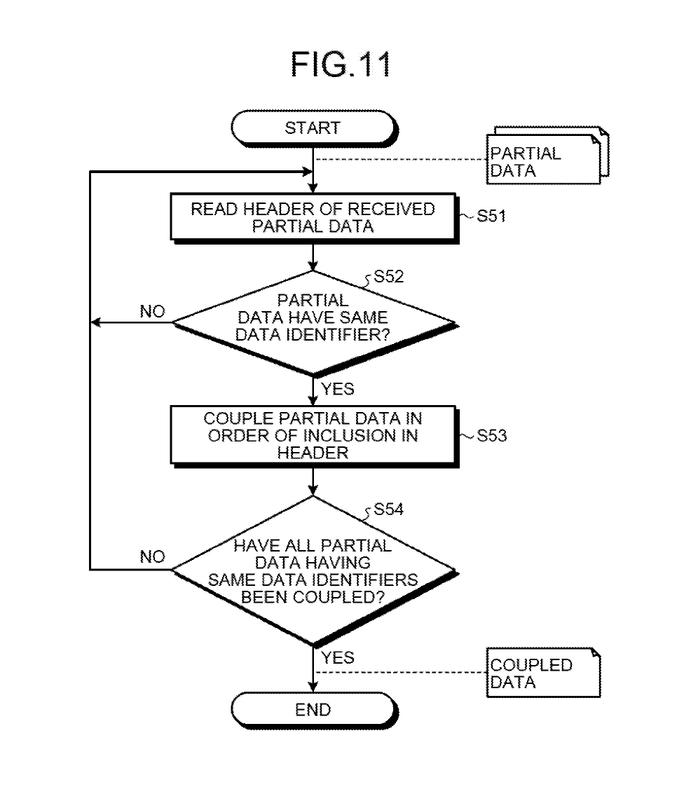

A flow of a data synthesizing process is described next. FIG. 11 is a flowchart illustrating a flow of the data synthesizing process. As illustrated in FIG. 11, an aggregation node reads a header of received partial data (Step S51). The aggregation node then performs comparison of the data identifiers between the pieces of partial data to determine whether the pieces of partial data have the same data identifier (Step S52). If the pieces of partial data do not have the same data identifier, the process returns to Step S51.

On the other hand, if the pieces of partial data have the same data identifier, the aggregation node couples the pieces of partial data in order of inclusion in the header (Step S53). The aggregation node then determines whether all the pieces of partial data having the same data identifier have been coupled (Step S54). If there is any partial data not having been coupled, the process returns to Step S51, and if all the pieces of partial data have been coupled, the process is finished.

In this manner, the aggregation node can restore the divided and transferred data by coupling the pieces of partial data based on the order, the data identifier, and the number of data divisions included in the header of the received partial data.

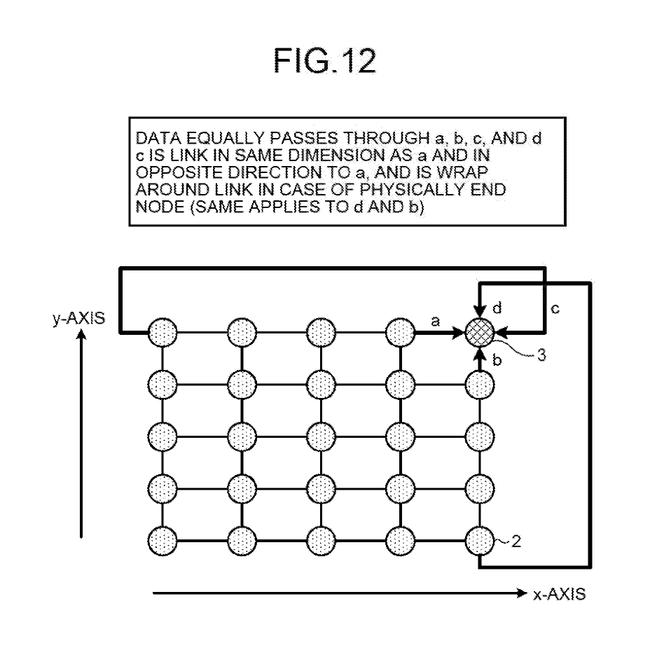

The routing in a two-dimensional torus is described next. FIG. 12 is an explanatory diagram of routing in a two-dimensional torus. As illustrated in FIG. 12, the IO node 3 receives the pieces of partial data from two directions of the x-axis direction and the y-axis direction respectively. Specifically, the IO node 3 receives the pieces of partial data via four links of a to d.

A link c is a link having a direction opposite to the direction of a link a regarding the x-axis, and is a wrap around link when the IO node 3 is a physically end node. Similarly, a link d is a link having a direction opposite to the direction of a link b regarding the y-axis, and is a wrap around link when the IO node 3 is the physically end node.

In this manner, in the routing in the two-dimensional torus, the transmission node can equalize the communication loads of the network by transmitting the pieces of partial data to the IO node 3 from four directions.

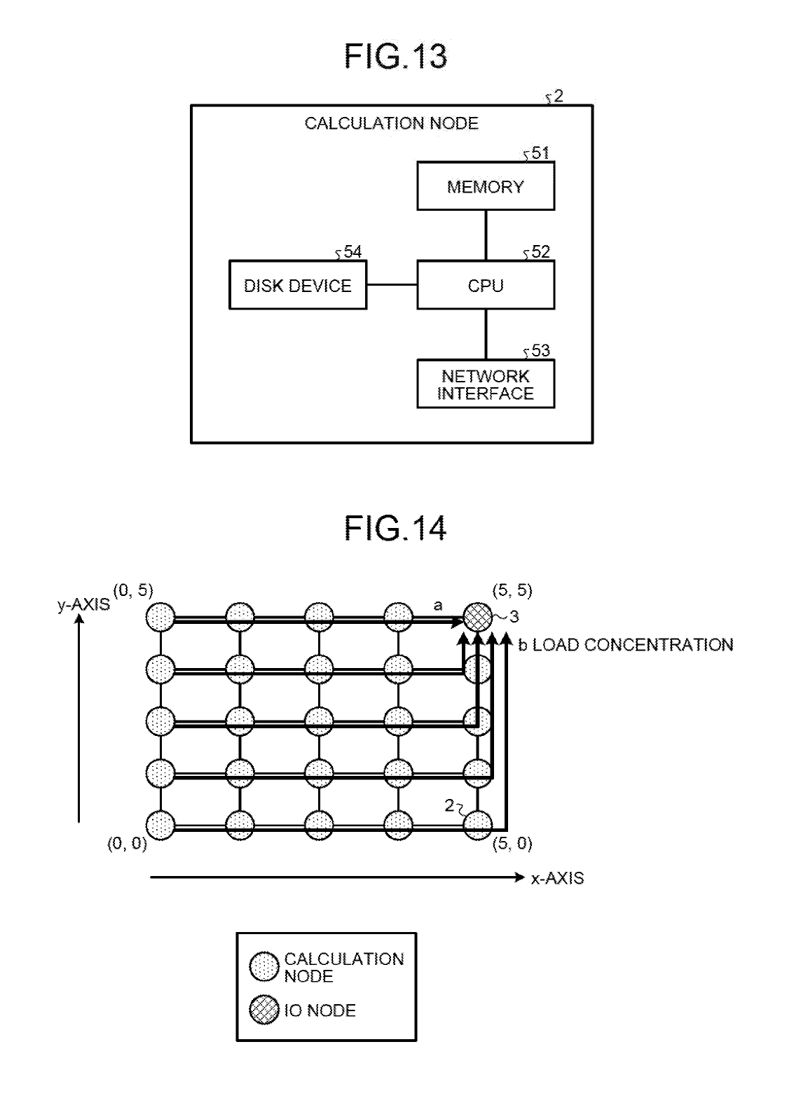

A hardware configuration of the calculation node 2 is described next. FIG. 13 is a diagram illustrating a hardware configuration of the calculation node 2. The respective functions illustrated in FIG. 3 can be realized by executing a data transfer program by the calculation node 2 illustrated in FIG. 13. As illustrated in FIG. 13, the calculation node 2 includes a memory 51, a CPU 52, a network interface 53, and a disk device 54.

The memory 51 is a RAM (Random Access Memory) that stores therein a program such as a data transfer program and a halfway execution result of the program. The CPU 52 is a central processing unit that reads the program from the memory 51 and executes the program. The network interface 53 is an interface for connecting the calculation node 2 to other calculation nodes 2 by interconnection. The disk device 54 is a non-volatile memory device that stores therein programs and data.

The data transfer program executed by the calculation node 2 is installed in the calculation node 2. The installed data transfer program is then stored in the disk device 54, read by the memory 51, and executed by the CPU 52.

As described above, in the present embodiment, the data division unit 25 divides the transfer data into the pieces of partial data to be transferred for each route. The first transfer unit 26 transmits the partial data to be transferred via the dimension-order routing route, among the divided and acquired partial data, by the dimension-order routing, and the second transfer unit 27 transmits the partial data to be transferred via the relay node route to the relay node 2a. Accordingly, the transmission node can prevent concentration of loads, which occurs in a certain link in the dimension-order routing.

In the present embodiment, because the first transfer unit 26 and the second transfer unit 27 transmit the log data to the IO node 3, the IO node 3 can collectively transmit the log data to the device that manages the log.

In the present embodiment, because the performance measurement unit 23 measures the data transfer speed of each route, and the data division unit 25 divides the data into the pieces of partial data based on the data transfer speed measured by the performance measurement unit 23, the difference in the arrival time between the pieces of partial data can be decreased.

In the present embodiment, a case in which log data is transmitted to the IO node 3 has been described. However, the present invention is not limited thereto, and the present embodiment is also applicable to a case where data is transmitted to a certain node.

According to an aspect, concentration of loads in a certain link can be prevented.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A parallel information processing device in which a plurality of information processing devices that perform parallel processing are connected in a mesh shape or a torus shape, wherein
each of the information processing devices includes
a division unit that divides data into pieces of partial data based on number of dimensions of parallel processing,
a first transmission unit that transmits first partial data among the pieces of partial data divided by the division unit to a certain information processing device via a first route based on a dimension-order routing, and
a second transmission unit that transmits second partial data different from the first partial data, among the pieces of partial data divided by the division unit, to the certain information processing device via a second route with a different dimension order from the first route.

2. The parallel information processing device according to claim 1, wherein
the certain information processing device includes
a reception unit that receives partial data respectively transmitted from the first transmission unit and the second transmission unit, and
a synthesis unit that synthesizes the partial data received by the reception unit.

3. The parallel information processing device according to claim 1, wherein
data divided by the division unit is log data, and
the certain information processing unit to which the first transmission unit and the second transfer unit respectively transmit partial data performs an input/output process including an output process of log data to other devices.

4. The parallel information processing device according to claim 1, wherein
each of the information processing devices further includes a measurement unit that measures a data transfer speed of the first route and the second route, and
the division unit divides the data based on a data transfer speed measured by the measurement unit.

5. A data transfer method performed by an information processing device that is connected with other information processing devices in a mesh shape or in a torus shape to establish a parallel information processing device, the data transfer method comprising:
dividing data into pieces of partial data based on number of dimensions of parallel processing;
transmitting first partial data among the pieces of partial data to a certain information processing device via a first route based on a dimension-order routing; and
transmitting second partial data different from the first partial data, among the pieces of partial data, to the certain information processing device via a second route with a different dimension order from the first route.

6. A non-transitory computer-readable recording medium having stored therein a program executed by an information processing device that is connected with other information processing devices in a mesh shape or in a torus shape and establishes a parallel information processing device, comprising:
dividing data into pieces of partial data based on number of dimensions of parallel processing;
transmitting first partial data among the pieces of partial data to a certain information processing device via a first route based on dimension-order routing; and
transmitting second partial data different from the first partial data, among the pieces of partial data, to the certain information processing device via a second route with a different dimension order from the first route.
